(19) United States
(12) Patent Application Publication
(10) Pub. No.: US 2026/0361376 A1
(43) Pub. Date: Nov. 12, 2026

(54) SIDELINK BEAM MEASUREMENT AND BEAM REPORTING

(71) Applicant: Apple Inc., Cupertino, CA (US)

(72) Inventors: Chunxuan Ye, San Diego, CA (US); Dan Wu, Beijing (CN); Dawei Zhang, Saratoga, CA (US); Hong He, San Jose, CA (US); Jie Cui, San Jose, CA (US); Wei Zeng, Saratoga, CA (US)

(21) Appl. No.: 19/153,461

(22) PCT Filed: Feb. 9, 2023
(86) PCT No.: PCT/CN2023/075219

§ 371 Date: Aug. 4, 2025

(51) Int. Cl. H04B 7/06; H04B 17/318; H04W 72/25

(52) U.S. Cl. CPC H04B 7/06952; H04B 7/0626; H04B 17/328; H04W 72/25

(57) ABSTRACT

Disclosed are methods, systems, apparatuses, and computer programs to perform SL beam measurement and beam reporting. In one aspect, a method for sidelink (SL) beam measurement and reporting can include actions of receiving, by a first UE, a plurality of SL channel state information reference signals (CSI-RS) transmitted by a second UE, with each of the plurality of SL CSI-RS having been transmitted, by the second UE, using a different transmission beam, and after receipt of the plurality of SL CSI-RS, transmitting, by the first UE, an SL beam report, to the second UE, that indicates a particular beam of the different transmission beams.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

The present disclosure is directed towards sidelink (SL) beam measurement and beam reporting design. The SL beam measurement and beam reporting design of the present disclosure comprises a plurality of solutions related to methods for SL beam measurement and reporting, methods for SL beam measurement and reporting requests, signaling used for SL beam reporting, and timing of SL beam reporting.

In accordance with one aspect of the present disclosure, a method for sidelink (SL) beam measurement and reporting is disclosed. In one aspect, the method can include actions of receiving, by a first UE, a plurality of SL channel state information reference signals (CSI-RS) transmitted by a second UE, with each of the plurality of SL CSI-RS having been transmitted, by the second UE, using a different transmission beam, and after receipt of the plurality of SL CSI-RS, transmitting, by the first UE, an SL beam report, to the second UE, that indicates a particular beam of the different transmission beams.

Other aspects includes apparatuses, systems, and computer programs for performing the actions of the aforementioned method.

The innovative method can include other optional features. For example, in some implementations, the SL beam report that indicates a particular beam of the different transmission beams includes at least a beam ID corresponding to the particular beam.

In some implementations, the SL beam report that indicates a particular beam of the different transmission beams includes at least a reference signal received power (RSRP) corresponding to the particular beam.

In some implementations, the SL beam report that indicates a particular beam of the different transmission beams includes at least (i) a beam ID corresponding to the particular beam and (ii) a reference signal received power (RSRP) corresponding to the particular beam.

In some implementations, the method can further include selecting, by the first UE, the particular beam of the different transmission beams based on a reference signal received power (RSRP) associated with each of the different transmission beams.

In some implementations, the selected particular beam of the different transmission beams has an RSRP that is greater than an RSRP associated with each of the other transmission beams of the different transmission beams.

In some implementations, the SL beam report is communicated using one or more MAC CE.

In some implementations, wherein the one or more MAC CE includes a single MAC CE indicating (i) a channel quality index (CQI), (ii) a ranking index (RI), and (iii) SL beam reporting, wherein the SL beam reporting includes at least (a) the SL beam ID of the particular beam having the greatest RS|RP of the different transmission beams, (b) an RSRP of the particular beam, or (c) both the SL beam ID of the particular beam having the greatest RS|RP of the different transmission beams and an RSRP of the particular beam.

In some implementations, the one or more MAC CE includes a single MAC CE indicating at least (i) an SL beam ID of the particular beam having a greatest RSRP of the different transmission beams and (ii) an RSRP of the particular beam.

In some implementations, the one or more MAC CE includes a single MAC CE indicating at least (i) an SL beam ID of the particular beam having a greatest RSRP of the different transmission beams or (ii) an RSRP of the particular beam.

In some implementations, the one or more MAC CE includes a plurality of MAC CE indicating a list of SL beam IDs, with each MAC CE of the plurality of MAC CE corresponding to an SL beam ID of a transmission beam and an associated SL beam RSRP.

In some implementations, the one or more MAC CE includes a plurality of MAC CE indicating an ordered list of SL beam IDs, each MAC CE of the plurality of MAC CE corresponding to an SL beam ID of a transmission beam having an RSRP that is greater than a threshold.

In some implementations, the method further can further include receiving, by the first UE, a transmission, from the second UE, that includes at least a first SL control information (SCI) indicating a start of SL beam measurement, and receiving, by the first UE, another transmission, from the second UE, that includes at least a second SCI indicating a start of SL beam reporting.

In some implementations, the first SCI is associated with an initial SL CSI-RS of the plurality of SL CSI-RS received by the first UE.

In some implementations, the first SCI is received before an initial SL CSI-RS of the plurality of SL CSI-RS.

In some implementations, a time gap between the initial SL CSI-RS and a start of SL beam reporting is limited by an upper bound.

In some implementations, the first SCI indicates a number of SL CSI-RS transmissions that are to occur before sidelink beam reporting starts.

In some implementations, the first SCI indicates a time window of SL CSI-RS transmissions that is to elapse before sidelink beam reporting starts.

In some implementations, the time window is limited by an upper bound.

In some implementations, the first SCI is transmitted during sidelink beam measurement configuration.

In some implementations, the first SCI is either SCI stage 1 or SCI stage 2.

In some implementations, the first SCI includes at least 1 bit to indicate the presence or absence of SL CSI-RS in the received transmission.

In some implementations, the first SCI includes at least 1 bit to indicate triggering of start of sidelink beam measurement.

In some implementations, the second SCI is associated with a last SL CSI-RS of the plurality of SL CSI-RS received by the first UE.

In some implementations, the second SCI is transmitted after a last SL CSI-RS of the plurality of SL CSI-RS received by the first UE.

In some implementations, a time gap between the second SCI and the start of SL beam reporting is limited by an upper bound.

In accordance with another innovative aspect of the present disclosure, a method for sidelink (SL) beam measurement and reporting is disclosed. In one aspect, the method can include actions of transmitting, by a first UE, a plurality of SL channel state information reference signals (CSI-RS) to a second UE, with each of the plurality of SL CSI-RS being transmitted, by the first UE, using a different transmission beam, receiving, by the first UE, a single SL beam report, from the second UE, that indicates a particular beam of the different transmission beams, and performing, by the first UE, a subsequent transmission using the particular beam.

Other aspects includes apparatuses, systems, and computer programs for performing the actions of the aforementioned method.

The innovative method can include other optional features. For example, in some implementations, the SL beam report that indicates a particular beam of the different transmission beams includes at least a beam ID corresponding to the particular beam.

In some implementations, the SL beam report that indicates a particular beam of the different transmission beams includes at least a reference signal received power (RSRP) corresponding to the particular beam.

In some implementations, the SL beam report that indicates a particular beam of the different transmission beams includes at least (i) a beam ID corresponding to the particular beam and (ii) a reference signal received power (RSRP) corresponding to the particular beam.

In some implementations, the SL beam report is communicated using one or more MAC CE.

In some implementations, the one or more MAC CE includes a single MAC CE indicating a channel quality index (CQI), a ranking index (RI), and SL beam reporting.

In some implementations, the SL beam reporting includes at least the SL beam ID of the particular beam having the greatest RS|RP of the different transmission beams, (ii) an RSRP of the particular beam, or (iii) both the SL beam ID of the particular beam having the greatest RS|RP of the different transmission beams and an RSRP of the particular beam.

In some implementations, the one or more MAC CE includes a single MAC CE indicating at least (i) an SL beam ID of the particular beam having a greatest RSRP of the different transmission beams and (ii) an RSRP of the particular beam.

In some implementations, the one or more MAC CE includes a single MAC CE indicating at least (i) an SL beam ID of the particular beam having a greatest RSRP of the different transmission beams or (ii) an RSRP of the particular beam.

In some implementations, the one or more MAC CE includes a plurality of MAC CE indicating a list of SL beam IDs, with each MAC CE of the plurality of MAC CE corresponding to an SL beam ID of a transmission beam and an associated SL beam RSRP.

In some implementations, the one or more MAC CE includes a plurality of MAC CE indicating an ordered list of SL beam IDs, each MAC CE of the plurality of MAC CE corresponding to an SL beam ID of a transmission beam having an RSRP that is greater than a threshold.

In some implementations, the method can further include transmitting, by the first UE, a transmission, to the second UE, that includes at least a first SL control information (SCI) indicating a start of SL beam measurement, and transmitting, by the first UE, another transmission, to the second UE, that includes at least a second SCI indicating a start of SL beam reporting.

In some implementations, the first SCI is associated with an initial SL CSI-RS of the plurality of SL CSI-RS transmitted by the first UE.

In some implementations, the first SCI is transmitted before an initial SL CSI-RS of the plurality of SL CSI-RS is transmitted by the first UE.

In some implementations, a time gap between the initial SL CSI-RS and a start of SL beam reporting is limited by an upper bound.

In some implementations, the first SCI indicates a number of SL CSI-RS transmissions that are to occur before sidelink beam reporting starts.

In some implementations, the first SCI indicates a time window of SL CSI-RS transmissions that is to elapse before sidelink beam reporting starts.

In some implementations, the time window is limited by an upper bound.

In some implementations, the first SCI is transmitted during sidelink beam measurement configuration.

In some implementations, the first SCI is either SCI stage 1 or SCI stage 2.

In some implementations, the first SCI includes at least 1 bit to indicate the presence or absence of SL CSI-RS in the transmission.

In some implementations, the first SCI includes at least 1 bit to indicate triggering of start of sidelink beam measurement.

In some implementations, the second SCI is associated with a last SL CSI-RS of the plurality of SL CSI-RS transmitted by the first UE.

In some implementations, a time gap between the second SCI and a start of SL beam reporting is limited by an upper bound.

In accordance with another innovative aspect of the present disclosure, a method for sidelink (SL) beam measurement and reporting is disclosed. In one aspect, the method can include transmitting, by a first UE, an SL channel state information reference signal (CSI-RS) to a second UE using a transmission beam, receiving, by the first UE, an SL beam report, from the second UE, that indicates a reference signal received power (RSRP) of the transmission beam, and determining, by the first UE, whether to perform a subsequent transmission using the transmission beam based on the received SL beam report.

Other aspects includes apparatuses, systems, and computer programs for performing the actions of the aforementioned method.

The innovative method can include other optional features. For example, in some implementations, the method can further include after receipt of the SL beam report, transmitting, by the first UE, a second SL CSI-RS to the second UE using a different transmission beam, receiving, by the first UE, a second SL beam report, from the second UE, that indicates an RSRP of the different transmission beam. In such implementations, determining, by the first UE, whether to perform a subsequent transmission using the transmission beam based on the received SL beam report can include performing, by the first UE, a subsequent transmission using a transmission beam that is selected based at least in part on (i) the RSRP of the transmission beam and (ii) the RSRP of the different transmission beam.

In some implementations, the method can further include receiving, by the first UE, a plurality of SL beam reports, from the second UE, wherein each SL beam report (i) corresponds to an SL CSI-RS transmitted to the second UE by the first UE and (ii) includes an RSRP of a transmission beam used to transmit the corresponding SL CSI-RS to the second UE. In such implementations, determining, by the first UE, whether to perform a subsequent transmission using the transmission beam based on the received SL beam report can include determining, by the first UE, a transmission beam for a subsequent transmission based on the plurality of SL beam reports.

In some implementations, determining, by the first UE, a transmission beam for a subsequent transmission based on the plurality of SL beam reports can include selecting, by the first UE, a transmission beam for a subsequent transmission that is associated with an RSRP satisfying a predetermined threshold.

In some implementations, determining, by the first UE, a transmission beam for a subsequent transmission based on the plurality of SL beam reports can include selecting, by the first UE, a transmission beam for a subsequent transmission that is associated with a greatest RSRP of each of the RSRPs indicated by a received SL beam report.

In some implementations, determining, by the first UE, whether to perform a subsequent transmission using the transmission beam based on the received SL beam report can include determining, by the first UE, whether the RSRP indicated by the received SL beam report satisfies a predetermined threshold, and based on determining, by the first UE, that the RSRP indicated by the received SL beam report satisfies a predetermined threshold, performing, by the first UE, a subsequent transmission using the transmission beam.

In some implementations, determining, by the first UE, whether to perform a subsequent transmission using the transmission beam based on the received SL beam report can include determining, by the first UE, whether the RSRP indicated by the received SL beam report satisfies a predetermined threshold, and based on determining, by the first UE, that the RSRP indicated by the received SL beam report does not satisfy a predetermined threshold, determining, by the first UE, to not perform a subsequent transmission using the transmission beam.

In some implementations, the SL beam report is communicated using one or more MAC CE.

In some implemetnations, the one or more MAC CE includes a single MAC CE indicating at least (i) an SL beam ID and (ii) an RSRP of the particular beam.

In some implementations, the one or more MAC CE includes a single MAC CE indicating at least an RSRP of the particular beam.

In some implementations, performing a subsequent transmission comprises transmitting actual data using the transmission beam based on the received SL beam report. In some implementations, the actual data comprises a transport block.

In accordance with another innovative aspect of the present disclosure, a method for sidelink (SL) beam measurement and reporting is disclosed. In one aspect, the method can include actions of receiving, by a first UE, an SL channel state information reference signal (CSI-RS) transmitted by a second UE using a transmission beam, and transmitting, by the first UE, an SL beam report, to the second UE, that indicates a reference signal received power (RSRP) of the transmission beam.

Other aspects includes apparatuses, systems, and computer programs for performing the actions of the aforementioned method.

The innovative method can include other optional features. For example, in some implementations, the SL beam report is communicated using one or more MAC CE.

In some implementations, the one or more MAC CE includes a single MAC CE indicating at least (i) an SL beam ID and (ii) an RSRP of the particular beam.

In some implementations, the one or more MAC CE includes a single MAC CE indicating at least (i) an SL beam ID or (ii) an RSRP of the particular beam.

In accordance with another innovative aspect of the present disclosure, a method for requesting sidelink (SL) measurement and reporting is disclosed. In one aspect, the method can include actions of performing, by a first UE, a first transmission that includes at least a first SL control information (SCI), to a second UE, that indicates a start of SL beam measurement, and performing, by the first UE, a second transmission that includes at least a second SCI, to the second UE, that indicates a start of SL beam reporting.

Other aspects includes apparatuses, systems, and computer programs for performing the actions of the aforementioned method.

The innovative method can include other optional features. For example, in some implementations, the first SCI is associated with an initial SL CSI-RS of a plurality of SL CSI-RS transmitted by the first UE, wherein each SL CSI-RS of the plurality of SL CSI-RS is transmitted using a different transmission beam.

In some implementations, the first SCI is transmitted, to the second UE, before an initial SL CSI-RS of a plurality of SL CSI-RS are transmitted by the first UE.

In some implementations, a time gap between the initial SL CSI-RS and the start of SL beam reporting is limited by an upper bound.

In some implementations, the first SCI indicates a number of SL CSI-RS transmissions that are to occur before sidelink beam reporting starts.

In some implementations, the first SCI indicates a time window of SL CSI-RS transmissions that is to elapse before sidelink beam reporting starts.

In some implementations, the time window is limited by an upper bound.

In some implementations, the first SCI is transmitted during sidelink beam measurement configuration.

In some implementations, the first SCI is either SCI stage 1 or SCI stage 2.

In some implementations, the first SCI includes at least 1 bit to indicate the presence or absence of SL CSI-RS in the first transmission.

In some implementations, the first SCI includes at least 1 bit to indicate triggering of start of sidelink beam measurement.

In some implementations, the second SCI is associated with a last SL CSI-RS of a plurality of SL CSI-RS transmitted by the first UE, wherein each SL CSI-RS of the plurality of SL CSI-RS is transmitted using a different transmission beam.

In some implementations, a time gap between the second transmission and the start of SL beam reporting is limited by an upper bound.

In some implementations, a time gap between the first transmission and the start of SL beam reporting is limited by an upper bound.

In some implementations, a second SCI is transmitted, to the second UE, after a last SL CSI-RS of a plurality of SL CSI-RS are transmitted by the first UE.

In some implementations, a time gap between the last SL CSI-RS and the start of SL beam reporting is limited by an upper bound.

In some implementations, the second SCI indicates a time window for SL beam reporting.

In some implementations, the second SCI indicates a type of SL beam reporting.

In some implementations, the second SCI is transmitted during sidelink beam measurement configuration.

In some implementations, the second SCI is either SCI stage 1 or SCI stage 2.

In some implementations, the second SCI includes at least 1 bit to indicate the triggering of a start of SL beam reporting.

In some implementations, the second SCI includes at least 1 bit to indicate an end of SL CSI-RS transmission.

In accordance with another innovative aspect of the present disclosure, a method for requesting sidelink (SL) measurement and reporting is disclosed. In one aspect, the method can include actions of performing, by a first UE, a plurality of transmissions, to a second UE, using a plurality of transmission beams, wherein each particular transmission of the plurality of transmission beams includes at least (i) a SL CSI-RS and (ii) an indication that triggers beam reporting by the second UE for the beam associated with the particular transmission, and receiving, by the first UE, an SL beam report, from the second UE, for each of the plurality of transmissions.

Other aspects includes apparatuses, systems, and computer programs for performing the actions of the aforementioned method.

The innovative method can include other optional features. For example, in some implementations, the indication that triggers beam reporting by the second UE for the beam associated with the particular transmission is an SL control information (SCI).

In some implementations, the SCI is an SCI stage 1 or an SCI stage 2.

In some implementations, the SCI includes at least a single bit indicating the presence or absence of SL CSI-RS in a particular transmission.

In some implementations, the SCI is transmitted during sidelink beam measurement configuration.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example communication system that includes sidelink (SL) communications, according to some implementations.

FIG. 2 illustrates an example of a system for SL beam measurement and beam reporting, according to some implementations.

FIG. 3 illustrates a flowchart of an example of a process for SL beam measurement and beam reporting to be performed by transmitting (Tx) user equipment (UE), according to some implementations.

FIG. 4 illustrates a flowchart of another example of a process for SL beam measurement and beam reporting to performed by a Tx UE, according to some implementations.

FIG. 5 illustrates a flowchart of an example of a process for SL beam measurement and beam reporting to be performed by a receiving (Rx) user equipment (UE), according to some implementations.

FIG. 6 illustrates a flowchart of another example of a process for SL beam measurement and beam reporting to be performed by an Rx UE, according to some implementations.

FIG. 7 illustrates another example of a system for SL beam measurement and beam reporting, according to some implementations.

FIG. 8 illustrates another example of a process for SL beam measurement and beam reporting to be performed by a Tx UE, according to some implementations.

FIG. 9 illustrates another example of a process for SL beam measurement and beam reporting to be performed by an Rx UE, according to some implementations.

FIG. 10 illustrates an example of system for SL beam measurement and beam reporting requests, according to some implementations.

FIG. 11 illustrates another example of a system for SL beam measurement and beam reporting requests, according to some implementations.

FIG. 12 illustrates a flowchart of an example of process for SL beam measurement and beam reporting requests to be performed by a Tx UE, according to some implementations.

FIG. 13 illustrates a flowchart of another example of a process for SL beam measurement and reporting requests to be performed by a Tx UE, according to some implementations.

FIGS. 14A-14C illustrate examples of MAC CEs that can be used for SL beam reporting, according to some implementations.

FIG. 15 illustrates an example user equipment (UE), according to some implementations.

FIG. 16 illustrates an example access node, according to some implementations.

### DETAILED DESCRIPTION

The present disclosure is directed towards sidelink (SL) beam measurement and beam reporting design. The SL beam measurement and beam reporting design of the present disclosure comprises a plurality of solutions related to methods for SL beam measurement and reporting, methods for SL beam measurement and reporting requests, signaling used for SL beam reporting, and timing of SL beam reporting.

The present disclosure differs from conventional beam measurement and reporting methods, as conventional beam measurement and reporting methods involve processes between a UE and a base station. In contrast, the SL beam measurement and beam reporting design of the present disclosure occur between two UEs. For example, a UE transmits references signals such as CSI-RS using a plurality of beams to another, receiving, UE. Then the receiving UE can measure the reference signal received power (RSRP) of each beam used to transmit the CSI-RS. Based on this measurement, the receiving UE can either (i) select one of the beams to be used by the transmitting UE for a subsequent transmission and, then, provide an SL beam report to the transmitting UE that indicates the selected beam for the subsequent transmission or (ii) provide the measured RSRP for one or more beams to the transmitting UE, which enables the transmitting UE to select the a particular beam for subsequent transmission based on the received RSRP measurement from the receiving UE. The transmitting UE can, thus, select a beam for a subsequent transmission without being configured to use that selected beam by a base station.

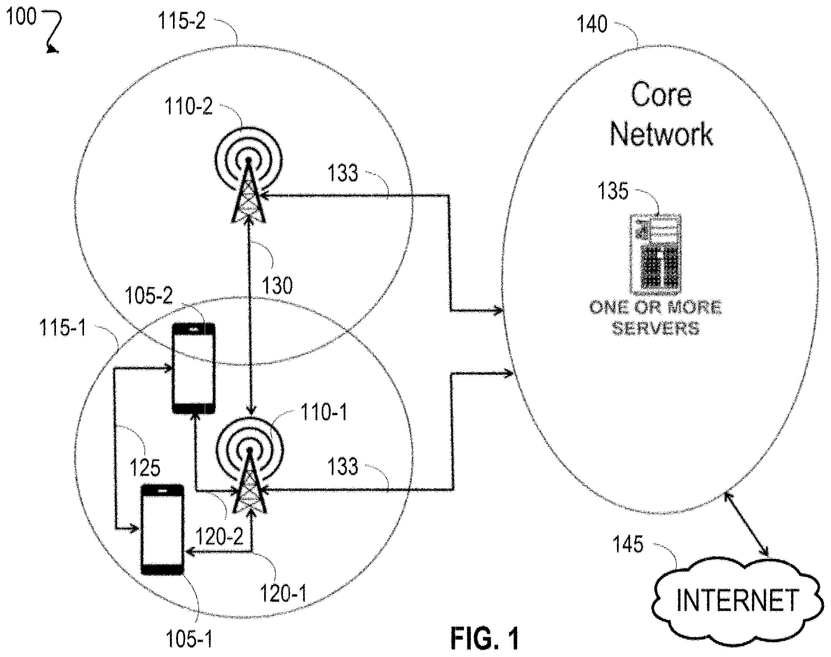

FIG. 1 illustrates an example communication system 100 that includes sidelink communications, according to some implementations. It is noted that the system of FIG. 1 is merely one example of a possible system, and that features of this disclosure may be implemented in other wireless communication systems.

The following description is provided for an example communication system that operates in conjunction with fifth generation (5G) networks as provided by 3GPP technical specifications. However, the example implementations are not limited in this regard and the described examples may apply to other networks that may benefit from the principles described herein, such as 3GPP Long Term Evolution (LTE) networks, Wi-Fi or Worldwide Interoperability for Microwave Access (WiMaX) networks, and the like. Furthermore, other types of communication standards are possible, including future 3GPP systems (e.g., Sixth Generation (6G)), IEEE 802.16 protocols, or the like. While aspects may be described herein using terminology commonly associated with 5G NR, aspects of the present disclosure can be applied to other systems, such as 3G, 4G, and/or systems subsequent to 5G (e.g., 6G).

Frequency bands for 5G NR may be separated into two different frequency ranges. Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1.

As shown, the communication system 100 includes a number of user devices. More specifically, the communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

In some implementations, the UEs 105 can directly communicate with base stations 110 via links 120 (link 120-1 and link 120-2 are collectively referred to as “link 120” or “links 120”), which utilize a direct interface with the base stations referred to as a “Uu interface.” Each of the links 120 can represent one or more channels. The links 120 are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein.

As shown, certain user devices may be able to conduct communications with one another directly, e.g., without an intermediary infrastructure device such as base station 110-1. In this example, UE 105-1 may conduct communications directly with UE 105-2. Similarly, the UE 105-2 may conduct communications directly with UE 105-1. Such peer-to-peer communications may utilize a “sidelink” interface such as a PC5 interface. In certain implementations, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs (also called PC5-RRC signaling). The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

In some implementations, the UEs 105 may be configured with parameters for communicating via the Uu interface and/or the sidelink interface. In some examples, the UEs 105 may be “pre-configured” with some parameters. In these examples, the parameters may be hardwired into the UEs 105 or coded into spec. Additionally and/or alternatively, the UEs 105 may receive the parameters from the one or more of the base stations 110.

To transmit/receive data to/from one or more base stations 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105-1 may connect with base station 110-1 via link 120 and simultaneously connect with UE 105-2 via sidelink 125.

In some implementations, one or more sidelink radio bearers may be established on the sidelink 125. The sidelink radio bearers can include signaling radio bearers (SL-SRB) and/or data radio bearers (SL-DRB).

The PC5 interface may alternatively be referred to as a sidelink interface and may include one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. In some examples, the sidelink interface can operate on an unlicensed spectrum (e.g., in the unlicensed 5 Gigahertz (GHz) and 6 GHz bands) or a (licensed) shared spectrum.

In one example, the sidelink interface implements vehicle-to-everything (V2X) communications. The V2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short-to medium-range (e.g., non-cellular) communications. Cellular-capable V2X communications may be called Cellular V2X (C-V2X) communications. C-V2X systems may use various cellular radio access technologies (RATs), such as 4G LTE or 5G NR RATs (or RATs subsequent to 5G, e.g., 6G RATs). Certain LTE standards usable in V2X systems may be called LTE-Vehicle (LTE-V) standards. As used herein in the context of V2X systems, and as defined above, the term “user devices” may refer generally to devices that are associated with mobile actors or traffic participants in the V2X system, e.g., mobile (able-to-move) communication devices such as vehicles, pedestrian user equipment (PUE) devices, and road side units (RSUs).

In some implementations, UEs 105 may be physical hardware devices capable of running one or more applications, capable of accessing network services via one or more radio links 120 with a corresponding base station 110 (also referred to as a “serving” base station), and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs and vice versa.

In some implementations, the base stations 110 are capable of communicating with one another over a backhaul connection 130 and may communicate with the one or more servers 135 within the CN 140 over another backhaul connection 133. The backhaul connections can be wired and/or wireless connections.

In some implementations, the UEs 105 are configured to use a resource pool for sidelink communications. A sidelink resource pool defines the time-frequency resources used for sidelink communications, and may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some examples, a UE may use different sub-channels for transmission of the transport block across multiple slots within its own resource selection window.

In some implementations, an exceptional resource pool may be configured for the UEs 105, perhaps by the base stations 110. The exceptional resource pool includes resources that the UEs 105 can use in exceptional cases, such as Radio Link Failure (RLF). The exceptional resource pool may include resources selected based on a random allocation of resources.

In some implementations, a UE that is initiating a communication with another UE is referred to as a transmitter UE (TX UE), and the UE receiving the communication is referred to as a receiver UE (RX UE). For example, UE 105-1 may be a TX UE and UE 105-2 may be an RX UE. Although FIG. 1 illustrates a single TX UE communicating with a single RX UE, a TX UE may communicate with more than one RX UE via sidelink.

In some implementations, a TX UE that is initiating sidelink communication may determine the available resources (e.g., sidelink resources) and may select a subset of these resources to communicate with an RX UE based on a resource allocation scheme. Example resource allocation schemes include Mode 1 and Mode 2 resource allocation schemes. In Mode 1 resource allocation scheme (referred to as “Mode 1”), the resources are allocated by a network node for in-coverage UEs. In Mode 2 resource allocation scheme (referred to as “Mode 2”), the TX UE selects the sidelink resources (e.g., sidelink transmission resources).

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

### Sidelink (SL) Beam Measurement and Reporting

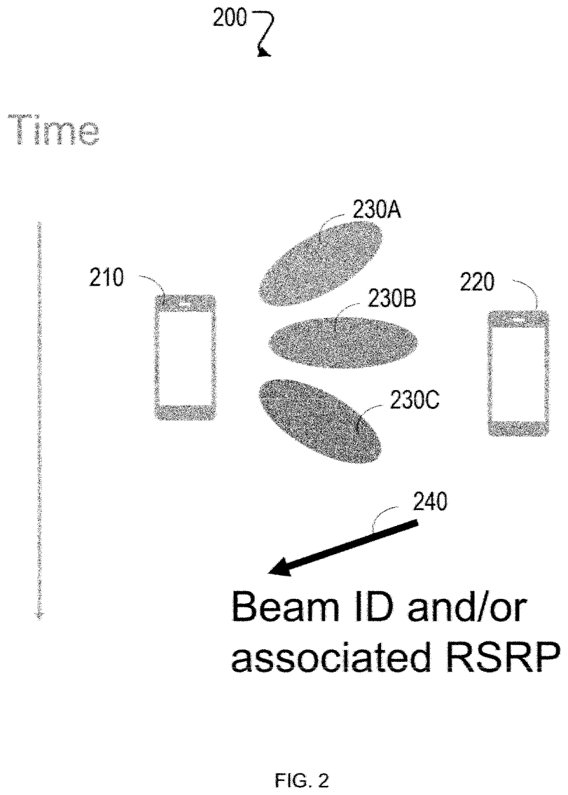

FIG. 2 illustrates an example of a system 200 for SL beam measurement and beam reporting, according to some implementations. The system 200 can include a first UE 210 and a second UE 220. The UEs 210 and 220 can be a UE as described with reference to 105-1, 105-2, or 1500. The first UE 210 may also be referred to herein as a transmission (Tx) UE and the second UE 220 may also be referred to herein as a receiving (Rx) UE. This because the Tx UE 210 transmits CSI-RS using different beams to the Rx UE 220 for measurement. However, different terms may be used to refer to each respective UE. Nonetheless, the identity of any particular UE described herein should be determined based not necessarily on what the UE is called, but instead, on the functionality performed by the UE.

In the system 200, the Tx UE 210 transmits a plurality of transmissions using a different transmission beams 230A, 230B, 230C. In the example of system 200, the different transmissions are made serially, over time, with the transmission on beam 230A being first, the transmission on beam 230B being second, and the transmission on beam 230C being third. In some implementations, the reference signal transmitted on each of the respective beams 230A, 230B, 230C can be a SL channel state information (CSI) reference signal (RS), or SL CSI-RS. However, the present disclosure is not so limited. Instead, in some implementations, the reference signal can be a SL SSB/PBSCH block.

The Rx UE 220 can receive each of the reference signals such as the plurality of SL CSI-RS transmitted via the plurality of beams 230A, 230B, and 230C. The Rx can then measure the RSRP of each beam 230A, 230B, and 230C. In the implementation of system 200, the Rx UE 220 is configured to only send a single SL beam report to the Tx UE 210 after all SL CSI-RS transmitting using the plurality of beams 230A, 230B, 230C have been sent by the Tx UE210. Thus, as shown in FIG. 2, the Rx UE 220 transmits a SL beam report 240 to the Tx UE 210 after SL CSI-RS have been received on beams 230A, 230B, 230C. In this example, this single SL beam report 240 is only sent after the SL CSI-RS is received on beam 230C, which is the final SL CSI-RS sent by the Tx UE 210.

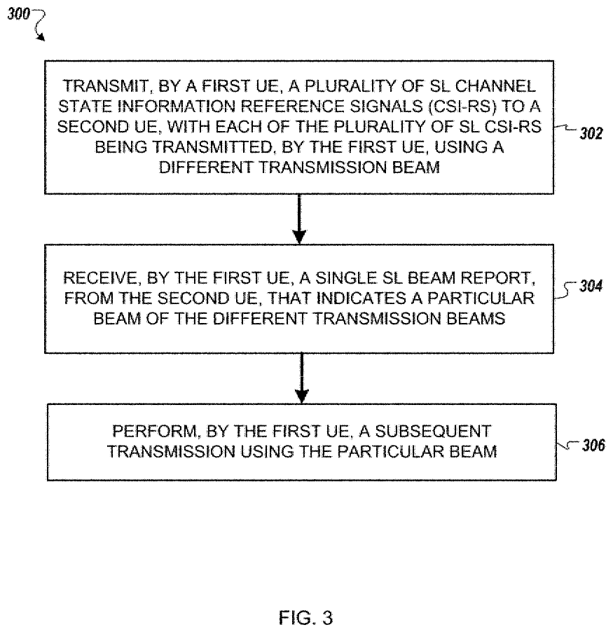

FIG. 3 illustrates a flowchart of an example of a process 300 for SL beam measurement and beam reporting to be performed by transmitting (Tx) user equipment (UE), according to some implementations. For convenience, the process 300 will be described as being performed by a US such as UE 105-1, UE 105-2, or UE1500.

A first UE can begin execution of the process 300 by transmitting a plurality of SL channel state information reference signals (CSI-RS) to a second UE (302). In such implementations, each of the plurality of SL CSI-RS being transmitted, by the first UE, using a different transmission beam.

The first UE can continue execution of the process 300 by receiving a single SL beam report, from the second UE, that indicates a particular beam of the different transmission beams (304).

The first UE can continue execution of the process 300 by performing a subsequent transmission using the particular beam (306). A subsequent transmission can include, for example, any actual data transmission that occurs using the particular beam indicated by the SL beam report. This subsequent transmission can include, for example, transmission of a transport block or any other data using the particular beam indicated by the SL beam report.

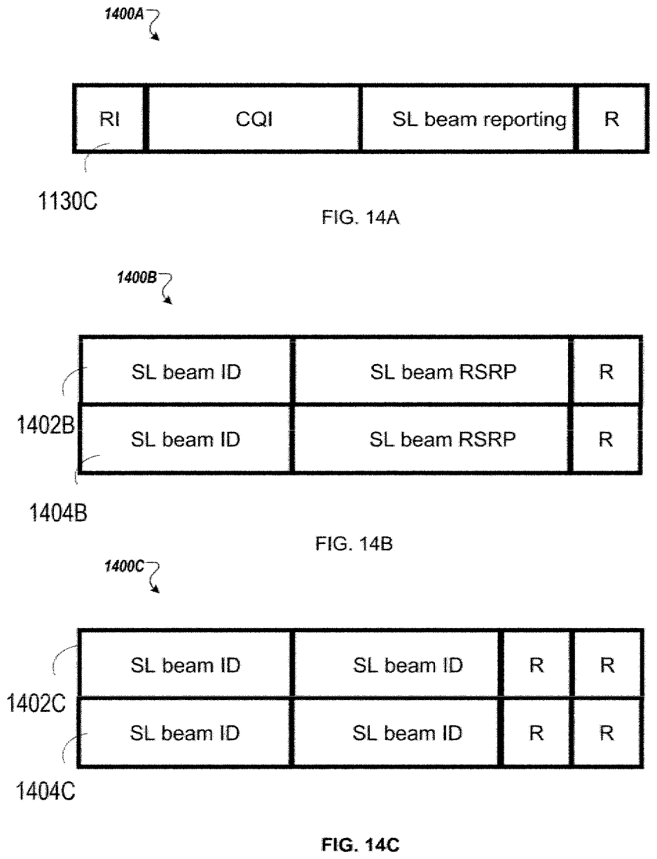

In some implementations, the SL beam report received at stage 304 can indicate that a particular beam of the different transmission beams includes at least a beam ID corresponding to the particular beam. In some implementations, the SL beam report can indicate the particular beam of the different transmission beams by including at least a reference signal received power (RSRP) corresponding to the particular beam. In yet other implementations, the SL beam report can indicate a particular beam of the different transmission beams by including at least (i) a beam ID corresponding to the particular beam and (ii) a reference signal received power (RSRP) corresponding to the particular beam. In some implementations, the SL beam report received at stage 304 can be communicated using one or more MAC CE. In some implementations, such as the implementation of FIG. 14A, the one or more MAC CE can be a single MAC CE 1400A that indicates at least a channel quality index (CQI), a ranking index (RI), and SL beam reporting. In such implementations, the SL beam reporting includes at least the SL beam ID of the particular beam having the greatest RSRP of the different transmission beams, (ii) an RSRP of the particular beam, or (iii) both the SL beam ID of the particular beam having the greatest RSRP of the different transmission beams and an RSRP of the particular beam.

In other implementations, the single MAC CE can indicate at least (i) an SL beam ID of the particular beam having a greatest RSRP of the different transmission beams and (ii) an RSRP of the particular beam. In some implementations, the one or more MAC CE can include a single MAC CE indicating at least (i) an SL beam ID of the particular beam having a greatest RSRP of the different transmission beams or (ii) an RSRP of the particular beam.

In some implementations, the one or more MAC CE can include a plurality of MAC CE 1400B indicating a list of SL beam IDs, with each MAC CE 1402B, 1404B of the plurality of MAC CE 1400B corresponding to an SL beam ID of a transmission beam and an associated SL beam RSRP. In other implementations, the one or more MAC CE includes a plurality of MAC CE 1400C indicating an ordered list of SL beam IDs, each MAC CE 1402C, 1404C of the plurality of MAC CE 1400C corresponding to an SL beam ID of a transmission beam having an RSRP that is greater than a threshold.

In some implementations, the first UE can continue execution of the process 300 by transmitting a transmission, to the second UE, that includes at least a first SL control information (SCI) indicating a start of SL beam measurement and transmitting, by the first UE, another transmission, to the second UE, that includes at least a second SCI indicating a start of SL beam reporting.

In some implementations, the first SCI can be associated with an initial SL CSI-RS of the plurality of SL CSI-RS transmitted by the first UE.

In some implementations, the first SCI can be transmitted before an initial SL CSI-RS of the plurality of SL CSI-RS is transmitted by the first UE.

In some implementations, a time gap between the initial SL CSI-RS and a start of SL beam reporting can be limited by an upper bound.

In some implementations, the first SCI indicates a number of SL CSI-RS transmissions that are to occur before sidelink beam reporting starts.

In some implementations, the first SCI indicates a time window of SL CSI-RS transmissions that is to elapse before sidelink beam reporting starts. In some implementations, the time window can be limited by an upper bound.

In some implementations, the first SCI is transmitted during sidelink beam measurement configuration.

In some implementations, the first SCI is either SCI stage 1 or SCI stage 2. In some implementations, the first SCI includes at least 1 bit to indicate the presence or absence of SL CSI-RS in the transmission. In some implementations, the first SCI includes at least 1 bit to indicate triggering of start of sidelink beam measurement.

In some implementations, the second SCI is associated with a last SL CSI-RS of the plurality of SL CSI-RS transmitted by the first UE.

In some implementations, a time gap between the second SCI and a start of SL beam reporting is limited by an upper bound.

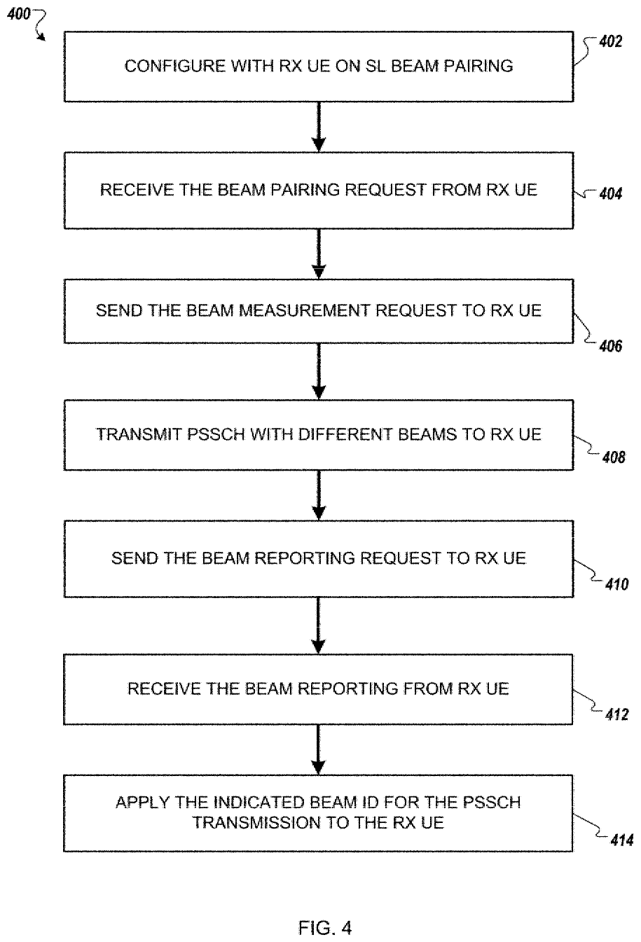

FIG. 4 illustrates a flowchart of another example of a process 400 for SL beam measurement and beam reporting to performed by a Tx UE, according to some implementations. For convenience, the process 400 will be described as being performed by a UE such as UE 105-1, UE 105-2, or UE1500.

A Tx UE can begin execution of the process 400 configuring with an Rx UE on SL beam pairing 402. The Tx UE can continue execution of the process 400 by receiving the beam pairing request from Rx UE 404. The Tx UE can continue execution of the process 400 by sending the beam measurement request to Rx UE 406. The Tx UE can continue execution of the process 400 by transmitting PSSCH with different beams to Rx UE 408. The Tx UE can continue execution of the process 400 by sending the beam reporting request to Rx UE 410. The Tx UE can continue execution of the process 400 by receiving the beam reporting from Rx UE 412. The Tx UE can continue execution of the process 400 by applying the indicated beam ID for the PSSCH transmission to the RX UE 414. Applying the indicated beam ID for the PSSCH transmission can include selecting a beam for the PSSCH transmission based on the indicated beam ID.

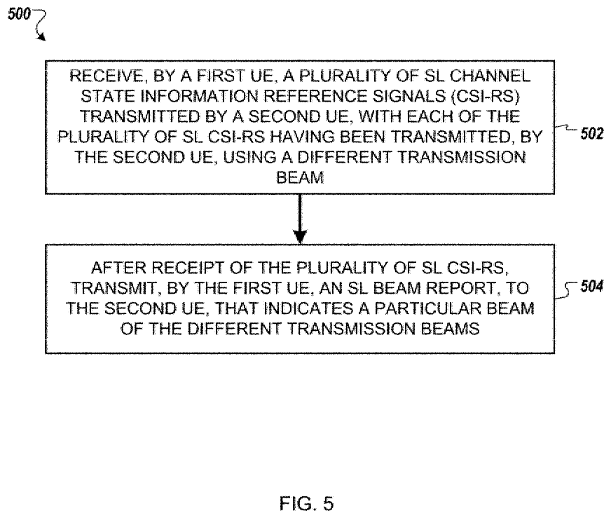

FIG. 5 illustrates a flowchart of an example of a process 500 for SL beam measurement and beam reporting to be performed by a receiving (Rx) user equipment (UE), according to some implementations. For convenience, the process 500 will be described as being performed by a UE such as UE 105-1, UE 105-2, or UE1500.

A first UE can begin execution of the process 500 by receiving a plurality of SL channel state information reference signals (CSI-RS) transmitted by a second UE (502). In such implementations, each of the plurality of SL CSI-RS have been transmitted, by the second UE, using a different transmission beam.

Then, after receipt of the plurality of SL CSI-RS, the first UE can continue execution of the process 500 by transmitting an SL beam report, to the second UE, that indicates a particular beam of the different transmission beams (504).

In some implementations, the SL beam report transmitted at stage 504 can indicate a particular beam of the different transmission beams by including at least a beam ID corresponding to the particular beam. In some implementations, the SL beam report transmitted at stage 504 can indicate a particular beam of the different transmission beams by including at least a reference signal received power (RSRP) corresponding to the particular beam. In some implementations, the SL beam report transmitted at stage 504 can indicate a particular beam of the different transmission beams by including at least (i) a beam ID corresponding to the particular beam and (ii) a reference signal received power (RSRP) corresponding to the particular beam.

In some implementations, execution of the process 500 by the first UE can include the first UE selecting the particular beam of the different transmission beams based on a reference signal received power (RSRP) associated with each of the different transmission beams. In some implementations, the selected particular beam of the different transmission beams has an RSRP that is greater than an RSRP associated with each of the other transmission beams of the different transmission beams.

In some implementations, the SL beam report transmitted at stage 504 can be communicated using one or more MAC CE. In some implementations, such as the implementation of FIG. 14A, the one or more MAC CE can be a single MAC CE 1400A that indicates at least a channel quality index (CQI), a ranking index (RI), and SL beam reporting. In such implementations, the SL beam report includes at least the SL beam ID of the particular beam having the greatest RSRP of the different transmission beams, (ii) an RSRP of the particular beam, or (iii) both the SL beam ID of the particular beam having the greatest RSRP of the different transmission beams and an RSRP of the particular beam.

In other implementations, the single MAC CE can indicate at least (i) an SL beam ID of the particular beam having a greatest RSRP of the different transmission beams and (ii) an RSRP of the particular beam. In some implementations, the one or more MAC CE can include a single MAC CE indicating at least (i) an SL beam ID of the particular beam having a greatest RSRP of the different transmission beams or (ii) an RSRP of the particular beam.

In some implementations, the SL beam report transmitted at stage 504 can be communicated using one or more MAC CE. In some implementations, such as the implementation of FIG. 14A, the one or more MAC CE can include a single MAC CE 1400A that indicates at least (i) an SL beam ID of the particular beam having a greatest RSRP of the different transmission beams and (ii) an RSRP of the particular beam. In some implementations, the one or more MAC CE can include a single MAC CE indicating at least (i) an SL beam ID of the particular beam having a greatest RSRP of the different transmission beams or (ii) an RSRP of the particular beam.

In some implementations, the one or more MAC CE can include a plurality of MAC CE 1400B indicating a list of SL beam IDs, with each MAC CE 1402B, 1404B of the plurality of MAC CE 1400B corresponding to an SL beam ID of a transmission beam and an associated SLs beam RSRP. In other implementations, the one or more MAC CE includes a plurality of MAC CE 1400C indicating an ordered list of SL beam IDs, each MAC CE 1402C, 1404C of the plurality of MAC CE 1400C corresponding to an SL beam ID of a transmission beam having an RSRP that is greater than a threshold.

In some implementations, the first UE can continue execution of the process 400 by (i) receiving a transmission, from the second UE, that includes at least a first SL control information (SCI) indicating a start of SL beam measurement and (ii) receiving another transmission, from the second UE, that includes at least a second SCI indicating a start of SL beam reporting.

In some implementations, the first SCI can be associated with an initial SL CSI-RS of the plurality of SL CSI-RS received by the first UE.

In some implementations, the first SCI is received before an initial SL CSI-RS of the plurality of SL CSI-RS.

In some implementations, a time gap between the initial SL CSI-RS and a start of SL beam reporting is limited by an upper bound.

In some implementations, the first SCI can indicate a number of SL CSI-RS transmissions that are to occur before sidelink beam reporting starts.

In some implementations, the first SCI can indicate a time window of SL CSI-RS transmissions that is to elapse before sidelink beam reporting starts. In some implementations, the time window can be limited by an upper bound.

In some implementations, the first SCI is transmitted during sidelink beam measurement configuration.

In some implementations, the first SCI is either SCI stage 1 or SCI stage 2. In some implementations, the first SCI can include at least 1 bit to indicate the presence or absence of SL CSI-RS in the received transmission. In some implementations, the first SCI can include at least 1 bit to indicate triggering of start of sidelink beam measurement.

In some implementations, the second SCI is associated with a last SL CSI-RS of the plurality of SL CSI-RS received by the first UE.

In some implementations, the second SCI is transmitted after a last SL CSI-RS of the plurality of SL CSI-RS received by the first UE.

In some implementations, a time gap between the second SCI and the start of SL beam reporting is limited by an upper bound.

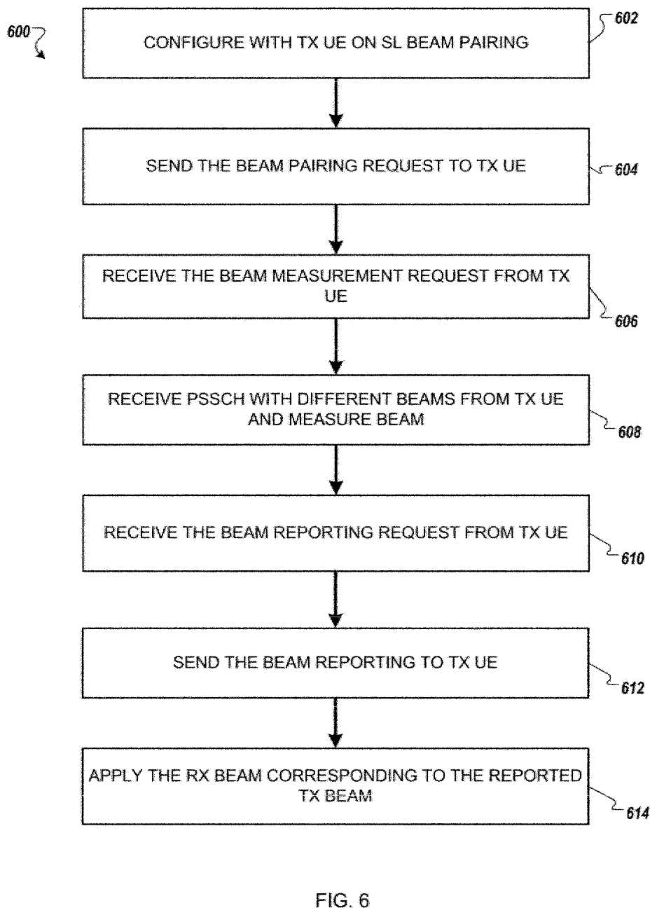

FIG. 6 illustrates a flowchart of another example of a process for SL beam measurement and beam reporting to be performed by an Rx UE, according to some implementations. For convenience, the process 400 will be described as being performed by a UE such as UE 105-1, UE 105-2, or UE1500.

An Rx UE can begin execution of the process 600 by configuring with Tx UE on SL beam paring (602). The Rx UE can continue execution of the process 600 by sending the beam pairing request to TX UE (604). The Rx UE can continue execution of the process 600 by receiving the beam measurement request from Tx UE (606). The Rx UE can continue execution of the process receiving PSSCH with different beams from Tx UE and measure beam (608). The Rx UE can continue execution of the process 600 by receiving the beam reporting request from Tx UE (610). The Rx UE can continue execution of the process 500 by sending the beam reporting to Tx UE (612). Then, the Rx UE can complete execution of the process 500 by applying the Rx beam corresponding to the reported Tx Beam (614). In some implementations, applying the Rx Beam corresponding to the reported Tx Beam can include the Rx UE selecting a beam that corresponds to the beam used by the Tx UE.

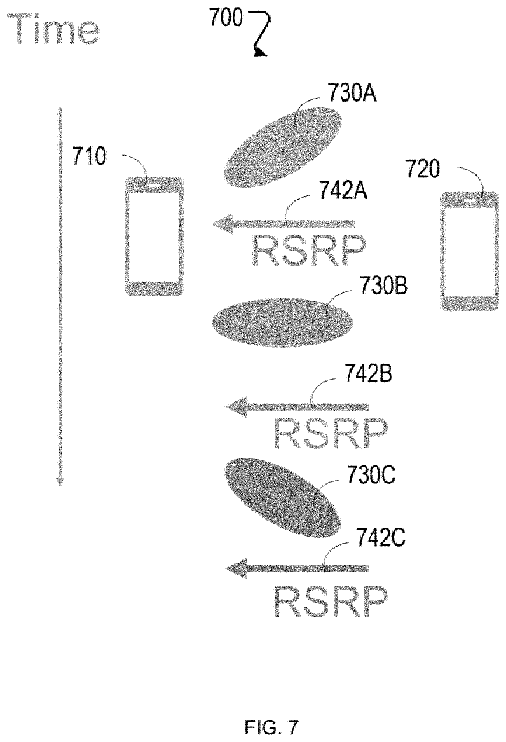

FIG. 7 illustrates another example of a system 700 for SL beam measurement and beam reporting, according to some implementations. The system 700 can include a first UE 710 and a second UE 720. The UEs 710 and 720 can be a UE as described with reference to 105-1, 105-2, or 1500. The first UE 710 may also be referred to herein as a transmission (Tx) UE and the second UE 720 may also be referred to herein as a receiving (Rx) UE. This because the Tx UE 710 transmits CSI-RS using different beams to the Rx UE 720 for measurement. However, different terms may be used to refer to each respective UE. Nonetheless, the identity of any particular UE described herein should be determined based not necessarily on what the UE is called, but instead, on the functionality performed by the UE.

In the system 700, the Tx UE 710 transmits a first transmission using a first transmission beam 730A. In some implementations, the reference signal transmitted on first transmission beam 730A can be a SL channel state information (CSI) reference signal (RS), or SL CSI-RS. However, the present disclosure is not so limited. Instead, in some implementations, the reference signal can be a SL SSB/PBSCH block.

In contrast to the system 200, the Rx UE 720 does not wait until all of the transmissions sent on all of beams 730A, 730B, 730C are completed before transmitting an SL beam report. Instead, the Rx UE 720 is configured to transmit an SL beam report after each reference signal transmission from the Tx UE. Accordingly, the Rx UE 720 does not provide a beam ID of a particular beam that is to be used by the Tx UE and, instead, transmits an SL beam report 742A that includes at least an RSRP of the beam 730A. Then, after receipt of the SL beam report 742A, the UE can either (i) select the beam 730A or (ii) send another reference signal transmission using transmission beam 730B. In the example of FIG. 7, the Tx UE 710 transmits another reference signal such as CSI-RS to the Rx UE 720 using the transmission beam 730B. Again, the Rx UE 720 does not provide a beam ID of a particular beam that is to be used by the Tx UE and, instead, transmits an SL beam report 742B that includes at least an RSRP of the beam 730B. Then, after receipt of the SL beam report 742B, the UE can either (i) select the beam 730A, (ii) select the beam 730B or (ii) send another reference signal transmission using transmission beam 730C. In the example of FIG. 7, the Tx UE 710 transmits another reference signal such as CSI-RS to the Rx UE 720 using the transmission beam 730B. Yet again, the Rx UE 720 does not provide a beam ID of a particular beam that is to be used by the Tx UE and, instead, transmits an SL beam report 742C that includes at least an RSRP of the beam 730C. Then, after receipt of the SL beam report 742C, the UE can either (i) select the beam 730A, beam 730B, beam 730C or (ii) send another reference signal transmission using transmission beam 730B. Here, in the example of system 700, the Tx UE 710 will select one of beam 730A, beam 730B, or beam 730 based on the different RSRP values provided by the Rx UE 720. For example, the Tx UE 710 can select the beam 730A, 730B, 730C having the greatest RSRP value. However, the present disclosure need not be so limited.

For example, in some implementations, the Tx UE 710 may terminate the process early if a received SL beam report (e.g., 742A) indicates that the RSRP of the certain beam (e.g., 730A) satisfies a predetermined threshold. In such instances, the Tx UE 710 can select the beam having an RSRP that satisfies a predetermined threshold and then perform a subsequent transmission using the selected beam.

Accordingly, the system 700 of FIG. 7 is configured to transmit a SL beam report after each SL CSI-RS is transmitted by the Tx UE using a transmission beam. The transmitted SL beam report can include an RSRP of the corresponding beam on which the SL CSI-RS was transmitted.

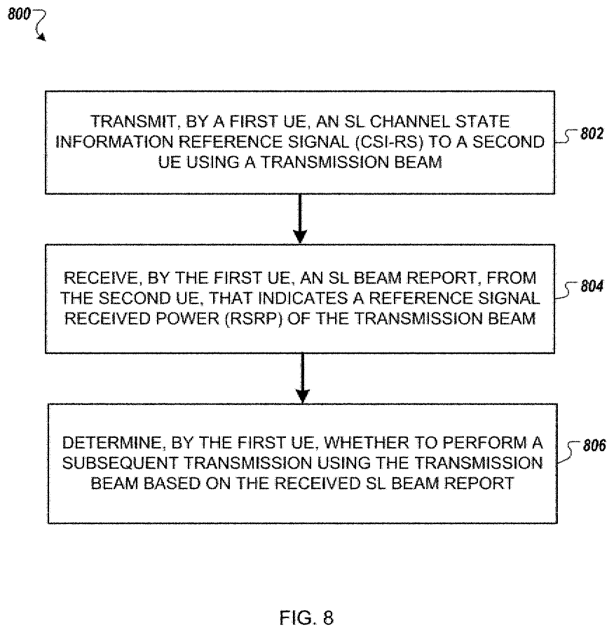

FIG. 8 illustrates another example of a process 800 for SL beam measurement and beam reporting to be performed by a Tx UE, according to some implementations. For convenience, the process 800 will be described as being performed by a UE such as UE 105-1, UE 105-2, or UE1500.

A first UE can begin execution of the process 800 by transmitting an SL channel state information reference signal (CSI-RS) to a second UE using a transmission beam (802).

The first UE can continue execution of the process 800 by receiving an SL beam report, from the second UE, that indicates a reference signal received power (RSRP) of the transmission beam (804).

The first UE can continue execution of the process 800 by determining whether to perform a subsequent transmission using the transmission beam based on the received SL beam report (806). A subsequent transmission can include, for example, any actual data transmission that would using the transmission beam corresponding to the RSRP indicated by the SL beam report. This subsequent transmission can include, for example, transmission of a transport block or any other data using the transmission beam corresponding to the RSRP indicated by the SL beam report.

In some implementations, after receipt of the SL beam report, the first UE can continue execution of the process 800 by transmitting a second SL CSI-RS to the second UE using a different transmission beam and then receiving a second SL beam report, from the second UE, that indicates an RSRP of the different transmission beam. In such implementations, determining whether to perform a subsequent transmission using the transmission beam based on the received SL beam report at stage 806 can include the first UE performing a subsequent transmission using a transmission beam that is selected based at least in part on (i) the RSRP of the transmission beam and (ii) the RSRP of the different transmission beam.

In some implementations, the first UE can continue execution the process 800 by receiving a plurality of SL beam reports, from the second UE, wherein each SL beam report (i) corresponds to an SL CSI-RS transmitted to the second UE by the first UE and (ii) includes an RSRP of a transmission beam used to transmit the corresponding SL CSI-RS to the second UE. In such implementations, determining whether to perform a subsequent transmission using the transmission beam based on the received SL beam report at stage 806 can include the first UE determining a transmission beam for a subsequent transmission based on the plurality of SL beam reports.

In some implementations, determining a transmission beam for a subsequent transmission based on the plurality of SL beam reports can include the first UE selecting a transmission beam for a subsequent transmission that is associated with an RSRP satisfying a predetermined threshold.

In some implementations, determining a transmission beam for a subsequent transmission based on the plurality of SL beam reports can include the first UE selecting a transmission beam for a subsequent transmission that is associated with a greatest RSRP of each of the RSRPs indicated by a received SL beam report.

In some implementations, determining whether to perform a subsequent transmission using the transmission beam based on the received SL beam report can include determining whether the RSRP indicated by the received SL beam report satisfies a predetermined threshold, and then, based on determining, by the first UE, that the RSRP indicated by the received SL beam report satisfies a predetermined threshold, performing, by the first UE, a subsequent transmission using the transmission beam.

In some implementations, determining whether to perform a subsequent transmission using the transmission beam based on the received SL beam report can include determining, by the first UE, whether the RSRP indicated by the received SL beam report satisfies a predetermined threshold, and then, based on determining, by the first UE, that the RSRP indicated by the received SL beam report does not satisfy a predetermined threshold, determining, by the first UE, to not perform a subsequent transmission using the transmission beam.

In some implementations, the SL beam report received at stage 804 can be communicated using one or more MAC CE. In some implementations, such as the implementation of FIG. 14A, the one or more MAC CE can be a single MAC CE 1400A that indicates at least a channel quality index (CQI), a ranking index (RI), and SL beam reporting. In such implementations, the SL beam reporting includes at least the SL beam ID of the particular beam measured, (ii) an RSRP of the particular beam measured, or (iii) both the SL beam ID of the particular beam measured and an RSRP of the particular beam measured.

In other implementations, the single MAC CE can indicate at least (i) an SL beam ID of the particular beam measured and (ii) an RSRP of the particular beam measured. In some implementations, the one or more MAC CE can include a single MAC CE indicating at least (i) an SL beam ID of the particular beam measured or (ii) an RSRP of the particular beam measured. Thus, in some implementations of the process 800, the MAC CE may at least the RSRP of the particular beam measured and may not include the SL beam ID of the particular beam measured.

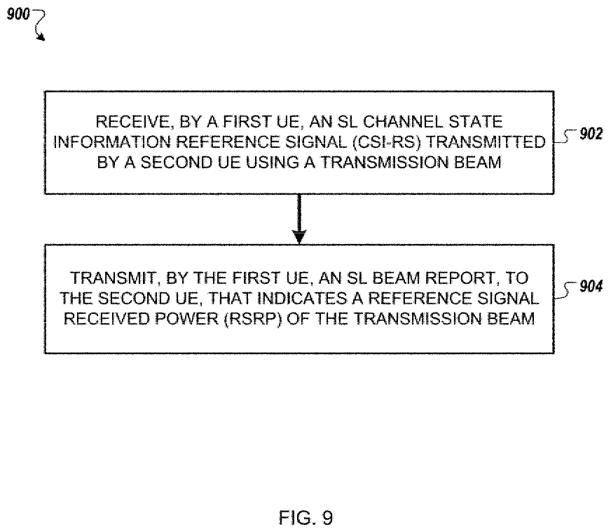

FIG. 9 illustrates another example of a process 900 for SL beam measurement and beam reporting to be performed by an Rx UE, according to some implementations. For convenience, the process 900 will be described as being performed by a UE such as UE 105-1, UE 105-2, or UE1500.

A first UE can begin execution of the process 900 by receiving an SL channel state information reference signal (CSI-RS) transmitted by a second UE using a transmission beam (902).

The first UE can continue execution of the process 900 by transmitting an SL beam report, to the second UE, that indicates a reference signal received power (RSRP) of the transmission beam (904).

In some implementations, the SL beam report transmitted at stage 904 can be communicated using one or more MAC CE. In some implementations, such as the implementation of FIG. 14A, the one or more MAC CE can include a single MAC CE 1400A that indicates at least (i) an SL beam ID of the particular beam having a greatest RSRP of the different transmission beams and (ii) an RSRP of the particular beam. In some implementations, the one or more MAC CE can include a single MAC CE indicating at least (i) an SL beam ID of the particular beam having a greatest RSRP of the different transmission beams or (ii) an RSRP of the particular beam.

In some implementations, the one or more MAC CE can include a plurality of MAC CE 1400B indicating a list of SL beam IDs, with each MAC CE 1402B, 1404B of the plurality of MAC CE 1400B corresponding to an SL beam ID of a transmission beam and an associated LS beam RSRP. In other implementations, the one or more MAC CE includes a plurality of MAC CE 1400C indicating an ordered list of SL beam IDs, each MAC CE 1402C, 1404C of the plurality of MAC CE 1400C corresponding to an SL beam ID of a transmission beam having an RSRP that is greater than a threshold.

### Sidelink (SL) Beam Measurement and Reporting Request

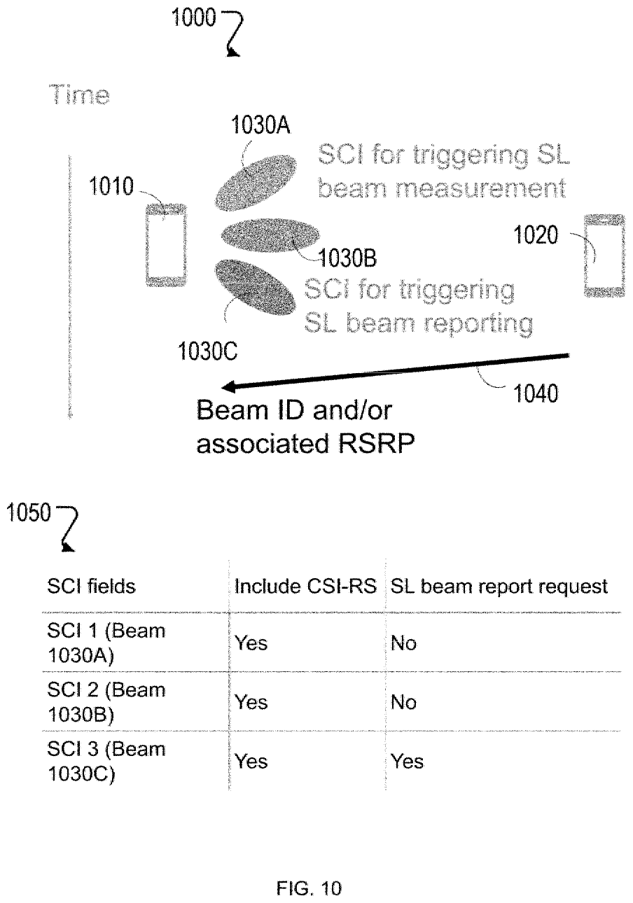

FIG. 10 illustrates an example of system 1000 for SL beam measurement and beam reporting requests, according to some implementations. The system 1000 can include a Tx UE 1010 and an Rx UE 1020. In the system 1000, the Tx UE 1010 can transmit SL beam measurement and beam reporting request to the Rx UE 1020. For example, the Tx UE 1010 can transmit request to the Rx UE 1020 that triggers SL beam measurement, a request to the RX UE 1020 that triggers SL beam reporting, or both.

In the example of system 1000, the Tx UE 1010 can transmit a request to the Rx UE 1020 to trigger SL beam management that is transmitted using the beam 1030A. Thus, in such implementations, the transmission beam 1030A may be used to transmit the SL beam measurement trigger and a CSI-RS. The SL Beam measurement trigger may be sidelink control information (SCI). The Rx UE, responsive to the SL beam measurement trigger, can begin measuring the RSRP of each beam 1030A, 130B, 1030C, that are each used by the Tx UE 1010 to transmit CSI-RS, as shown in table 1050. Then, the Tx UE 1010 transmits an SL beam reporting trigger to the Rx UE 1020 that causes the Rx UE to transmit an SL beam report request 1040. The SL beam reporting trigger can be SCI. In this example of system 1000, where the system begins measurement responsive to the SL beam measurement trigger transmitted using beam 1030A and continues to measure the RSRP of beams until the SL beam reporting trigger is received via beam 1030C. Then, the Rx UE 1020 selects the beam having the greatest RSRP and transmits an SL beam report 1040 to the Tx UE 1010 that indicates the beam ID of the selected beam, the RSRP of the selected beam, or both.

Regarding the SL beam measurement trigger, the trigger may be implemented via the SCI associated with the initial sidelink CSI-RS. Alternatively, the SL beam measurement trigger may be implemented via an independent SCI transmitted to the Rx UE 1020 initial sidelink CSI-RS (e.g., before the beam 1030A). In some implementations, the SCI used for the SL beam measurement trigger may indicate the total number of sidelink CSI-RS transmissions before sidelink beam reporting. In some implementations, the SCI used for the SL beam measurement trigger may indicate the total time window of sidelink CSI-RS transmissions before sidelink beam reporting. In some implementations, the SCI used for the SL beam measurement trigger may be transmitted via the sidelink beam measurement configuration. The SCI for the SL beam measurement trigger may be either SCI stage 1 or SCI stage 2. In some implementations, 1 bit of the SCI can be used to indicate the existence of SL CSI-RS in the current transmission. In some implementations, 1 bit of the SCI to indicate the triggering of sidelink beam measurement.

Regarding the SL beam reporting trigger, the trigger may be implemented via SCI associated with the last sidelink CSI-RS. Alternatively, the SL beam reporting trigger can be implemented via an independent SCI transmitted from the Tx UE 1010 to the Rx UE 1020 after the last sidelink CSI-RS. In some implementations, the SCI for the SL beam reporting trigger may indicate the time window of sidelink beam reporting. In some implementations, the SCI for the SL beam reporting trigger may indicate the type (or contents) of sidelink beam reporting (i.e., beam ID with the largest RSRP, or RSRPs of all beams). In some implementations, the SCI for the SL beam reporting trigger may be via the sidelink beam reporting configuration. The SCI for he SL beam reporting trigger can be either SCI stage 1 or SCI stage 2. In some implementations, 1 bit of the SCI can be used to indicate the triggering of SL beam reporting. In some implementations, 1 bit to indicate the end of SL CSI-RS transmission. In some implementations, these two bits may be combined. In some implementations, triggering of sidelink beam reporting could be separately indicated from the existence of sidelink CSI-RS for beam measurement.

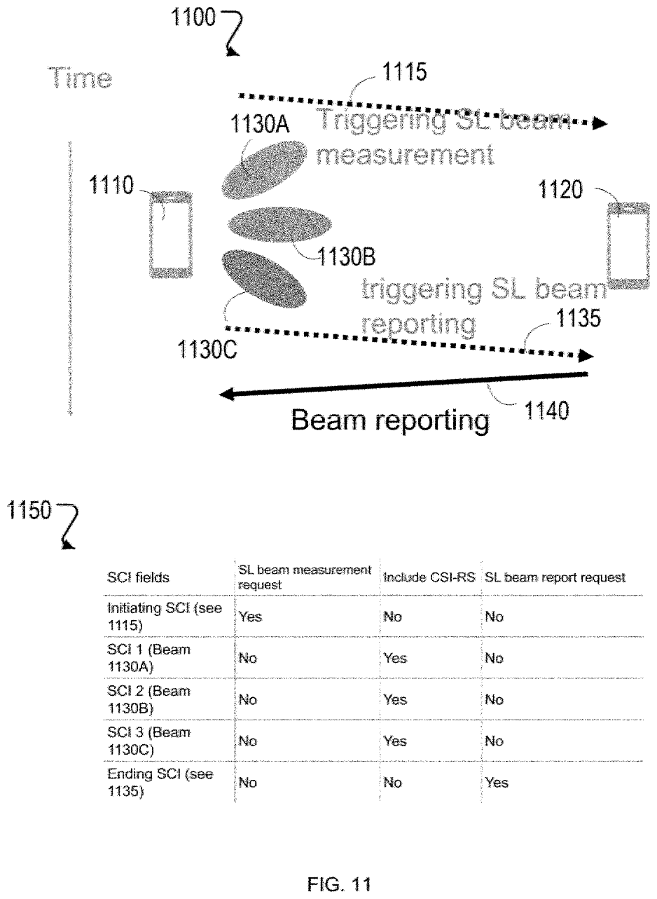

FIG. 11 illustrates another example of a system 1100 for SL beam measurement and beam reporting requests, according to some implementations. The system 1100 can include a Tx UE 1110 and an Rx UE 1120. In the system 1100, the Tx UE 1110 can transmit SL beam measurement and beam reporting request to the Rx UE 1120. For example, the Tx UE 1110 can transmit request to the Rx UE 1120 that triggers SL beam measurement, a request to the RX UE 1120 that triggers SL beam reporting, or both.

In the example of system 1100, the SL beam measurement trigger 1115 and the SL beam reporting trigger 1135 are transmitted using independent SCI that are not transmitted using the same beam that is used to transmit a CSI-RS. For example, in system 1100, an SCI is used to transmit an SL beam measurement trigger 1115 to the Rx UE 1120 before the initial CSI-RS is transmitted to the Rx UE 1120 using the transmission beam 1130A. This causes the Rx UE 1120 to begin measuring the RSRP of the beams 1130A, 1130B, 1130C. And, then, after the last CSI-RS transmitted using beam 1130C, the Tx UE 1110 transmits an independent SCI after the last SCI-RS transmitted using 1130C that causes the Rx UE 1120 to transmit an SL beam report 1140. Then, the Rx UE 1120 selects the beam having the greatest RSRP and transmits an SL beam report 1140 to the Tx UE 1010 that indicates the beam ID of the selected beam, the RSRP of the selected beam, or both. The SCI fields of each SCI is shown in 1150, along with whether each SCI field has an SL beam measurement request, includes CSI-RS, and/or an SL beam report request.

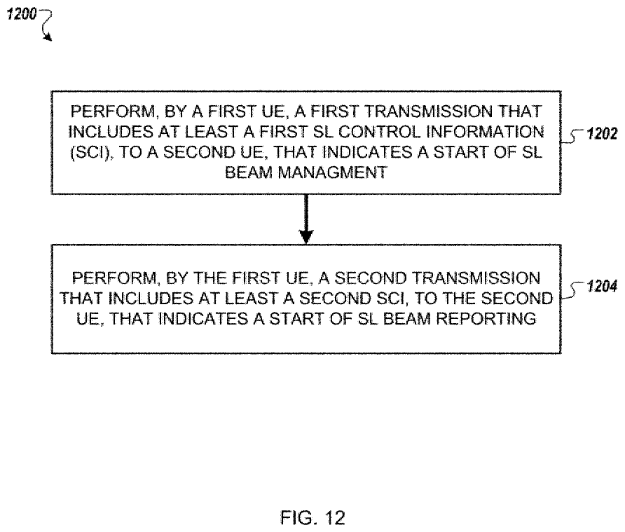

FIG. 12 illustrates a flowchart of an example of process 1200 for SL beam measurement and beam reporting requests to be performed by a Tx UE, according to some implementations. For convenience, the process 1200 will be described as being performed by a UE such as UE 105-1, UE 105-2, or UE1500.

A first UE can begin execution of the process 1200 by performing a first transmission that includes at least a first SL control information (SCI), to a second UE, that indicates a start of SL beam measurement (1202).

The first UE can continue execution of the process 1200 by performing a second transmission that includes at least a second SCI, to the second UE, that indicates a start of SL beam reporting (1204).

In some implementations, the first SCI is associated with an initial SL CSI-RS of a plurality of SL CSI-RS transmitted by the first UE, wherein each SL CSI-RS of the plurality of SL CSI-RS is transmitted using a different transmission beam.

In some implementations, the first SCI is transmitted, to the second UE, before an initial SL CSI-RS of a plurality of SL CSI-RS are transmitted by the first UE.

In some implementations, a time gap between the initial SL CSI-RS and the start of SL beam reporting is limited by an upper bound.

In some implementations, the first SCI indicates a number of SL CSI-RS transmissions that are to occur before sidelink beam reporting starts.

In some implementations, the first SCI indicates a time window of SL CSI-RS transmissions that is to elapse before sidelink beam reporting starts.

In some implementations, the time window is limited by an upper bound.

In some implementations, the first SCI is transmitted during sidelink beam measurement configuration.

In some implementations, the first SCI is either SCI stage 1 or SCI stage 2.

In some implementations, the first SCI includes at least 1 bit to indicate the presence or absence of SL CSI-RS in the first transmission.

In some implementations, the first SCI includes at least 1 bit to indicate triggering of start of sidelink beam measurement.

In some implementations, the second SCI is associated with a last SL CSI-RS of a plurality of SL CSI-RS transmitted by the first UE, wherein each SL CSI-RS of the plurality of SL CSI-RS is transmitted using a different transmission beam.

In some implementations, a time gap between the second transmission and the start of SL beam reporting is limited by an upper bound.

In some implementations, a time gap between the first transmission and the start of SL beam reporting is limited by an upper bound.

In some implementations, the second SCI is transmitted, to the second UE, after a last SL CSI-RS of a plurality of SL CSI-RS are transmitted by the first UE.

In some implementations, a time gap between the last SL CSI-RS and the start of SL beam reporting is limited by an upper bound.

In some implementations, the second SCI indicates a time window for SL beam reporting.

In some implementations, the second SCI indicates a type of SL beam reporting.

In some implementations, the second SCI is transmitted during sidelink beam measurement configuration.

In some implementations, the second SCI is either SCI stage 1 or SCI stage 2.

In some implementations, the second SCI includes at least 1 bit to indicate the triggering of a start of SL beam reporting.

In some implementations, the second SCI includes at least 1 bit to indicate an end of SL CSI-RS transmission.

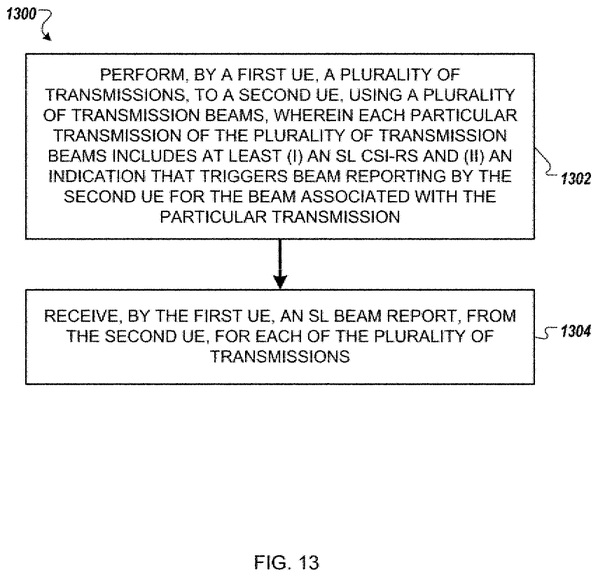

FIG. 13 illustrates a flowchart of another example of a process 1300 for SL beam measurement and reporting requests to be performed by a Tx UE, according to some implementations. For convenience, the process 1200 will be described as being performed by a UE such as UE 105-1, UE 105-2, or UE1500.

A first UE can begin execution of the process 1300 by performing a plurality of transmissions, to a second UE, using a plurality of transmission beams, wherein each particular transmission of the plurality of transmission beams includes at least (i) a SL CSI-RS and (ii) an indication that triggers beam reporting by the second UE for the beam associated with the particular transmission (1302).

The first UE can continue execution of the process 1300 by receiving an SL beam report, from the second UE, for each of the plurality of transmissions.

In some implementations, an indication that triggers beam reporting by the second UE for the beam associated with the particular transmission is an SL control information (SCI).

In some implementations, the SCI is an SCI stage 1 or an SCI stage 2.

In some implementations, the SCI includes at least a single bit indicating the presence or absence of SL CSI-RS in a particular transmission.

In some implementations, the SCI is transmitted during sidelink beam measurement configuration.

### Timing of Sidelink (SL) Beam Reporting

Using techniques of the present disclosure, a designer can implement timing of sidelink beam reporting. In some implementations, the time gap between sidelink beam reporting and sidelink beam reporting request may be limited by an upper bound. In some implementations, the time gap between sidelink beam reporting and sidelink beam measurement request may be limited by an upper bound. In some implementations, the time gap between sidelink beam reporting and the initial sidelink CSI-RS transmission for initial beam pairing or for beam maintenance may be limited by an upper bound. In some implementations, the time gap between sidelink beam reporting and the last sidelink CSI-RS transmission for initial beam pairing or for beam maintenance may be limited by an upper bound.

The upper bound may be (pre)configured per resource pool or configured by RC5-RRC. In some implementations, the same or different latency bound is used for the timing of sidelink beam reporting and for the timing of sidelink CSI reporting (parameter of “sl-LatencyBoundCSI-Report”). In some implementations, if the sidelink beam reporting is not received by a transmitter UE within a latency bound, then the initial beam pairing procedure is considered as failed.

### Signaling of Sidelink (SL) Beam Reporting

FIGS. 14A-14C illustrate examples of MAC CEs that can be used for SL beam reporting, according to some implementations.

The SL beam reports described herein can be transmitted or received. In some implementations, such as the implementation of FIG. 14A, the one or more MAC CE can be a single MAC CE 1400A that indicates at least a channel quality index (CQI), a ranking index (RI), and SL beam reporting. In such implementations, the SL beam reporting includes at least the SL beam ID of the particular beam having the greatest RSRP of the different transmission beams, (ii) an RSRP of the particular beam, or (iii) both the SL beam ID of the particular beam having the greatest RSRP of the different transmission beams and an RSRP of the particular beam.

In other implementations, the single MAC CE can indicate at least (i) an SL beam ID of the particular beam having a greatest RSRP of the different transmission beams and (ii) an RSRP of the particular beam. In some implementations, the one or more MAC CE can include a single MAC CE indicating at least (i) an SL beam ID of the particular beam having a greatest RSRP of the different transmission beams or (ii) an RSRP of the particular beam.

In some implementations, the one or more MAC CE can include a plurality of MAC CE 1400B indicating a list of SL beam IDs, with each MAC CE 1402B, 1404B of the plurality of MAC CE 1400B corresponding to an SL beam ID of a transmission beam and an associated SL beam RSRP. In other implementations, the one or more MAC CE includes a plurality of MAC CE 1400C indicating an ordered list of SL beam IDs, each MAC CE 1402C, 1404C of the plurality of MAC CE 1400C corresponding to an SL beam ID of a transmission beam having an RSRP that is greater than a threshold.

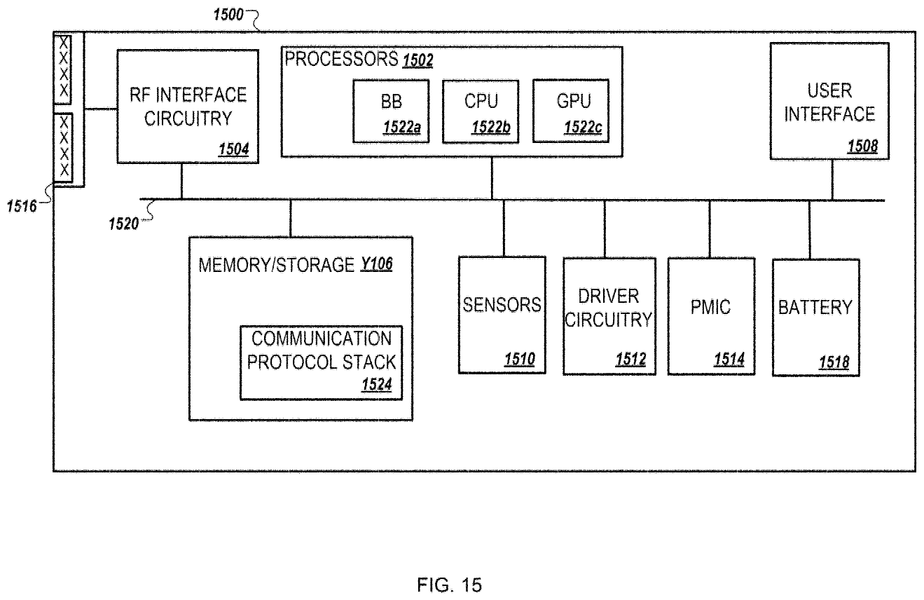

FIG. 15 illustrates an example UE 1500, according to some implementations. The UE 1500 may be similar to and substantially interchangeable with UEs 105 of FIG. 1.

The UE 1500 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 1500 may include processors 1502, RF interface circuitry 1504, memory/storage 1506, user interface 1508, sensors 1510, driver circuitry 1512, power management integrated circuit (PMIC) 1514, one or more antenna(s) 1516, and battery 1518. The components of the UE 1500 may be implemented as integrated circuits (ICs), portions thereof, discrete electronic devices, or other modules, logic, hardware, software, firmware, or a combination thereof. The block diagram of FIG. 15 is intended to show a high-level view of some of the components of the UE 1500. However, some of the components shown may be omitted, additional components may be present, and different arrangement of the components shown may occur in other implementations.

The components of the UE 1500 may be coupled with various other components over one or more interconnects 1520, which may represent any type of interface, input/output, bus (local, system, or expansion), transmission line, trace, optical connection, etc. that allows various circuit components (on common or different chips or chipsets) to interact with one another.

The processors 1502 may include processor circuitry such as, for example, baseband processor circuitry (BB) 1522A, central processor unit circuitry (CPU) 1522B, and graphics processor unit circuitry (GPU) 1522C. The processors 1502 may include any type of circuitry or processor circuitry that executes or otherwise operates computer-executable instructions, such as program code, software modules, or functional processes from memory/storage 1506 to cause the UE 1500 to perform operations as described herein.

In some implementations, the baseband processor circuitry 1522A may access a communication protocol stack 1524 in the memory/storage 1506 to communicate over a 3GPP compatible network. In general, the baseband processor circuitry 1522A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1504. The baseband processor circuitry 1522A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 1506 may include one or more non-transitory, computer-readable media that includes instructions (for example, communication protocol stack 1524) that may be executed by one or more of the processors 1502 to cause the UE 1500 to perform various operations described herein. The memory/storage 1506 include any type of volatile or non-volatile memory that may be distributed throughout the UE 1500. In some implementations, some of the memory/storage 1506 may be located on the processors 1502 themselves (for example, L1 and L2 cache), while other memory/storage 1506 is external to the processors 1502 but accessible thereto via a memory interface. The memory/storage 1506 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1504 may include transceiver circuitry and radio frequency front module (RFEM) that allows the UE 1500 to communicate with other devices over a radio access network. The RF interface circuitry 1504 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 1516 and proceed to filter and amplify (with a low-noise amplifier) the signal. The signal may be provided to a receiver of the transceiver that downconverts the RF signal into a baseband signal that is provided to the baseband processor of the processors 1502.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 1516. In various implementations, the RF interface circuitry 1504 may be configured to transmit/receive signals in a manner compatible with NR access technologies.

The antenna(s) 1516 may include one or more antenna elements to convert electrical signals into radio waves to travel through the air and to convert received radio waves into electrical signals. The antenna elements may be arranged into one or more antenna panels. The antenna(s) 1516 may have antenna panels that are omnidirectional, directional, or a combination thereof to enable beamforming and multiple input, multiple output communications. The antenna(s) 1516 may include microstrip antennas, printed antennas fabricated on the surface of one or more printed circuit boards, patch antennas, phased array antennas, etc. The antenna(s) 1516 may have one or more panels designed for specific frequency bands including bands in FR1 or FR2.

The user interface 1508 includes various input/output (I/O) devices designed to enable user interaction with the UE 1500. The user interface 1508 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1500.

The sensors 1510 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1512 may include software and hardware elements that operate to control particular devices that are embedded in the UE 1500, attached to the UE 1500, or otherwise communicatively coupled with the UE 1500. The driver circuitry 1512 may include individual drivers allowing other components to interact with or control various input/output (I/O) devices that may be present within, or connected to, the UE 1500. For example, driver circuitry 1512 may include a display driver to control and allow access to a display device, a touchscreen driver to control and allow access to a touchscreen interface, sensor drivers to obtain sensor readings of sensors 1510 and control and allow access to sensors 1510, drivers to obtain actuator positions of electro-mechanic components or control and allow access to the electro-mechanic components, a camera driver to control and allow access to an embedded image capture device, audio drivers to control and allow access to one or more audio devices.

The PMIC 1514 may manage power provided to various components of the UE 1500. In particular, with respect to the processors 1502, the PMIC 1514 may control power-source selection, voltage scaling, battery charging, or DC-to-DC conversion.

In some implementations, the PMIC 1514 may control, or otherwise be part of, various power saving mechanisms of the UE 1500. A battery 1518 may power the UE 1500, although in some examples the UE 1500 may be mounted deployed in a fixed location, and may have a power supply coupled to an electrical grid. The battery 1518 may be a lithium ion battery, a metal-air battery, such as a zinc-air battery, an aluminum-air battery, a lithium-air battery, and the like. In some implementations, such as in vehicle-based applications, the battery 1518 may be a typical lead-acid automotive battery.

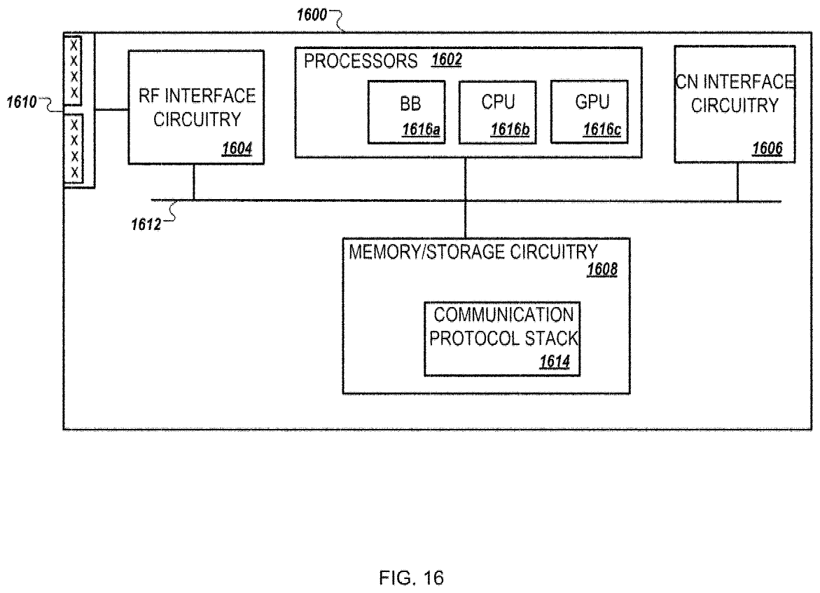

FIG. 16 illustrates an example access node 1600 (e.g., a base station or gNB), according to some implementations. The access node 1600 may be similar to and substantially interchangeable with base stations 110. The access node 1600 may include processors 1602, RF interface circuitry 1604, core network (CN) interface circuitry 1606, memory/storage circuitry 1608, and one or more antenna(s) 1610.

The components of the access node 1600 may be coupled with various other components over one or more interconnects 1612. The processors 1602, RF interface circuitry 1604, memory/storage circuitry 1608 (including communication protocol stack 1614), antenna(s) 1610, and interconnects 1612 may be similar to like-named elements shown and described with respect to FIG. 15. For example, the processors 1602 may include processor circuitry such as, for example, baseband processor circuitry (BB) 1616A, central processor unit circuitry (CPU) 1616B, and graphics processor unit circuitry (GPU) 1616C.

The CN interface circuitry 1606 may provide connectivity to a core network, for example, a 5th Generation Core network (5GC) using a 5GC-compatible network interface protocol such as carrier Ethernet protocols, or some other suitable protocol. Network connectivity may be provided to/from the access node 1600 via a fiber optic or wireless backhaul. The CN interface circuitry 1606 may include one or more dedicated processors or FPGAs to communicate using one or more of the aforementioned protocols. In some implementations, the CN interface circuitry 1606 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1600 that operates in an NR or 5G system (for example, a gNB), and the term “E-UTRAN node” or the like may refer to an access node 1600 that operates in an LTE or 4G system (e.g., an eNB). According to various implementations, the access node 1600 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1600 may be implemented as one or more software entities running on server computers as part of a virtual network, which may be referred to as a CRAN and/or a virtual baseband unit pool (vBBUP). In V2X scenarios, the access node 1600 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

1-20. (canceled)

21. One or more processors configured to, when executing instructions stored in a memory, perform operations comprising:
receiving first sidelink control information (SCI) that indicates a start of sidelink beam measurement;
receiving second SCI that indicates a start of sidelink beam reporting;
receiving a plurality of sidelink channel state information reference signals (CSI-RS) in accordance with the first SCI, wherein each of the plurality of sidelink CSI-RS is transmitted using a different transmission beam; and
after receipt of the plurality of sidelink CSI-RS, causing transmission of a sidelink beam report in accordance with the second SCI, wherein the sidelink beam report indicates a particular beam of the different transmission beams.

22. The one or more processors of claim 21, wherein the sidelink beam report that indicates a particular beam of the different transmission beams includes at least (i) a beam ID corresponding to the particular beam or (ii) a reference signal received power (RSRP) corresponding to the particular beam.

23. The one or more processors of claim 21, wherein the sidelink beam report that indicates a particular beam of the different transmission beams includes at least (i) a beam ID corresponding to the particular beam and (ii) a reference signal received power (RSRP) corresponding to the particular beam.

24. The one or more processors of claim 21, the operations further comprising:
selecting the particular beam of the different transmission beams based on a reference signal received power (RSRP) associated with each of the different transmission beams.

25. The one or more processors of claim 21, wherein the sidelink beam report is communicated using one or more MAC CE.

26. The one or more processors of claim 25, wherein the one or more MAC CE includes a single MAC CE indicating (i) a channel quality index (CQI), (ii) a ranking index (RI), and (iii) sidelink beam reporting, wherein the sidelink beam reporting includes at least (a) a sidelink beam ID of the particular beam having the greatest RSRP of the different transmission beams, (b) an RSRP of the particular beam, or (c) both the sidelink beam ID of the particular beam having the greatest RSRP of the different transmission beams and an RSRP of the particular beam.

27. The one or more processors of claim 25, wherein the one or more MAC CE includes a single MAC CE indicating at least (i) an sidelink beam ID of the particular beam having a greatest RSRP of the different transmission beams or (ii) an RSRP of the particular beam.

28. The one or more processors of claim 25, wherein the one or more MAC CE includes a plurality of MAC CE indicating a list of sidelink beam IDs, with each MAC CE of the plurality of MAC CE corresponding to an sidelink beam ID of a transmission beam and an associated sidelink beam RSRP.

29. The one or more processors of claim 25, wherein the one or more MAC CE includes a plurality of MAC CE indicating an ordered list of sidelink beam IDs, each MAC CE of the plurality of MAC CE corresponding to an sidelink beam ID of a transmission beam having an RSRP that is greater than a threshold.

30. The one or more processors of claim 21, wherein the first SCI is associated with an initial sidelink CSI-RS of the plurality of sidelink CSI-RS.

31. The one or more processors of claim 21, wherein first SCI is received before an initial sidelink CSI-RS of the plurality of sidelink CSI-RS.

32. The one or more processors of claim 21, wherein a time gap between an initial sidelink CSI-RS and a start of sidelink beam reporting is limited by an upper bound.

33. The one or more processors of claim 21, wherein the first SCI indicates a number of sidelink CSI-RS transmissions that are to occur before sidelink beam reporting starts.

34. The one or more processors of claim 21,
wherein the first SCI indicates a time window of sidelink CSI-RS transmissions that is to elapse before sidelink beam reporting starts, and
wherein the time window is limited by an upper bound.

35. The one or more processors of claim 21, wherein the second SCI is associated with a last sidelink CSI-RS of the plurality of sidelink CSI-RS.

36. The one or more processors of claim 21, wherein the second SCI is transmitted after a last sidelink CSI-RS of the plurality of sidelink CSI-RS.

37. The one or more processors of claim 21, a time gap between the second SCI and the start of sidelink beam reporting is limited by an upper bound.

38. One or more processors configured to, when executing instructions stored in a memory, perform operations comprising:
causing transmission of first SCI that indicates a start of sidelink beam measurement;
causing transmission of second SCI that indicates a start of sidelink beam reporting;
causing transmission of a plurality of sidelink CSI-RS in accordance with the first SCI, wherein each of the plurality of sidelink CSI-RS is transmitted using a different transmission beam; and
after transmission of the plurality of sidelink CSI-RS, receiving an sidelink beam report in accordance with the second SCI, wherein the sidelink beam report indicates a particular beam of the different transmission beams.

39. The one or more processors of claim 38, wherein the sidelink beam report that indicates a particular beam of the different transmission beams includes at least (i) a beam ID corresponding to the particular beam or (ii) a reference signal received power (RSRP) corresponding to the particular beam.

40. A method comprising:
receiving first SCI that indicates a start of sidelink beam measurement;
receiving second SCI that indicates a start of sidelink beam reporting;
receiving a plurality of sidelink CSI-RS in accordance with the first SCI, wherein each of the plurality of sidelink CSI-RS is transmitted using a different transmission beam; and
after receipt of the plurality of sidelink CSI-RS, transmitting a sidelink beam report in accordance with the second SCI, wherein the sidelink beam report indicates a particular beam of the different transmission beams.
